(19) United States
(12) Patent Application Publication
(10) Pub. No.: US 2005/0193022 A1
(43) Pub. Date: Sep. 1, 2005

(54) Method and apparatus for lossless compression and decompression of data

(76) Inventors: Aldis Rigerts, Rigas raj. (LV); Valdis Shkesters, Riga (LV)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/508,770

(22) PCT Filed: Mar. 21, 2003
(86) PCT No.: PCT/LV03/00002

§ 371 Date: Sep. 22, 2004

(30) Foreign Application Priority Data
Mar. 22, 2002 (LV) P-02-45

(51) Int. Cl. G06F 12/00

(52) U.S. Cl. 707/200

(57) ABSTRACT

The present invention relates to universal lossless data compression and decompression methods, as well as to apparatus for their implementation. The method is based on predicting the characters of data stream being processed by comparing them with predictors in one or several predictor tables and counting consecutively predicted characters, thus reducing considerably the number of output operations. Addressing in predictor tables is performed by means of one or several hash strings, each of which being formed by means of an unique hash function correlative with the input data. Processing the data stream in such a way allows eliminating the compression rate limitation that depends on the taken character length, thus increasing the compression rate and, at the same time, decreasing data processing time sufficiently.

The present invention relates to universal lossless data compression and decompression methods, as well as to apparatus for their implementation.

Data compression methods can be characterized by several key parameters, such as speed, compression rate, required memory space and simplicity of implementation. Depending on the application of the method and the problem to be solved it is usually necessary to find a compromise between these parameters. At the present stage of IT development the compression speed, as well as suitability of the compression methods for compression on the network protocol level become increasingly important. At the moment there are several methods known as widely used, for example, the LZ based and Predictor methods.

Theoretical background of the LZ based data compression methods is described in the works of Abraham Lempel and Jacob Ziv, published in IEEE Transactions on Information Theory, IT-23-3, May 1977, pp. 337-343 and IEEE Transactions on Information Theory, IT-24-5, September 1978, pp. 530-536. The data compression and decompression system, which is known as LZW system, and which is adopted as a standard V.42 bis in compression and decompression used in modems, is described, for example, in the U.S. Pat. No 4,558,302.

It is known that the LZ based methods provide good compression rate, but it has a relatively low speed, because complicated data structures are used requiring long processing time. Besides, it has to be noted that due to complicated data structures implementation of this method in the form of specialized chips is cumbersome and a relatively high memory capacity is required for its application.

Theoretical background for using the methods with Predictor is described in the works of Timo Raita and Jukka Teuhola “Text compression using prediction,” 1986 ACM Conference on Research and Development in Information Retrieval, September 1986 and “Predictive text compression by hashing,” The Tenth Annual International ACM SIGIR Conference on Research and Development in Information Retrieval, November 1987. This data compression and decompression method is also disclosed in the U.S. Pat. No. 5,229,768.

The Predictor method is considerably faster, simpler and needs less memory space in comparison with the LZ based methods, but the compression rate is usually lower. A distinctive feature of this method is that, irrespective of the characteristics of the data to be compressed, it has a limit of compression rate, which in its turn depends on the length of the character chosen for the particular implementation. Typically the length of the character is taken as 8 bits defined by the historically formed situation. In this case the maximum compression rate is 8 times, even in the case when the characteristics of the data to be compressed apparently allows achieving much better results.

Therefore, there is a need for a new lossless data compression and decompression method, which would be enough universal and where the drawbacks of the known methods would be eliminated.

Surprisingly it was found, that, basing on a prediction of characters of data stream being processed by comparing the characters with the predictors stored in one or more predictor tables and by counting consecutively predicted characters, thus reducing essentially the number of output operations, it is possible to eliminate the compression rate limitation, that depends on the taken character length, and, at the same time, to increase the data processing speed significantly.

The present invention provides an improved method for coding an input data character stream to obtain a compressed output code stream, which method includes the steps of:
a) counting consecutively predicted characters by comparing a character of the input data character stream with a predictor stored in a predictor table and addressed by a hash string, said predictor table comprising a plurality of predictors, said predictors being the characters of the input data stream and/or predetermined values, and said hash strings being formed by means of a hash function correlative with the input data;
b) coding a number of the consecutively predicted characters and an unpredicted character immediately succeeding the consecutively predicted characters;
c) optional updating the predictor table by storing the unpredicted character into a cell of the predictor table, said cell being addressed by said hash string;
d) updating the hash string.

Besides, if it is required by implementation of a specific method, the above step (b) according to the invention may further comprise the steps of:
i) comparing said unpredicted character with a predictor stored in the next predictor table;
ii) coding the number of the consecutively predicted characters and an identifier of said next predictor table, if said unpredicted character matches the predictor stored in said next predictor table; or
iii) coding the number of the consecutively predicted characters and the unpredicted character immediately succeeding the consecutively predicted characters, if said unpredicted character does not match the predictor stored in said next predictor table.

Furthermore, in the case, when said unpredicted character and predictor stored in the next predictor table do not match (step iii), the method according to the invention provides that the steps (i) to (iii) can be performed in a recursive way, until all the existing predictor tables are used.

Possibility to use several predictor tables increases the number of successful prediction cases and thus also the data compression rate, and the speed as well.

Increasing of the compression speed is considerably facilitated by the possibility to make parallel comparison of the character of input data character stream with the predictors stored in two or more existing predictor tables.

In order to provide better adaptation to the data being compressed and thereby increasing their compression rate even more, one or several hash strings can be used for addressing the predictors in various predictor tables, each hash string being formed by means of an unique hash function, correlative with the input data.

Further, if it is necessary to adjust to a specific problem, for example, to faster adaptation or to better compression rate, the method according to this invention can include an optional step of updating the predictor tables in accordance with a predetermined strategy.

At the beginning of the process the method according to the invention includes an additional step for initialization of the hash string, where a predetermined value is assigned to the hash string.

According to the invention, a decompression method is also provided for decompression of the compressed code stream for obtaining the original data stream, which method includes the steps adequate to the steps of a particular implementation of the compression method and contains adequate data structures. The method according to the invention ensures that a precisely restored initial data character stream is obtained by decompression.

Apart from the compression and decompression methods described above, in order to achieve the objectives of this invention, appropriate compression and decompression apparatus comprising means which are adapted for performing the respective steps of the compression and decompression methods are provided.

The methods and apparatus according to this invention can be adapted for a very wide range of requirements by varying the number of predictor tables, hash functions and their number, strategies for updating the predictor tables, taken character length, type of implementation (software, hardware) etc., and, separately or together with other methods, can be used in a variety of applications, for example, for creation of backup copies of data, for data compression in on-line data transmission systems, for compression of information placed on the internet, for compression of data in mobile and portable equipment.

Using of simple data structures in the method according to the invention facilitates achieving a high compression speed and decreasing the required memory space.

Hereinafter, the invention will be described in detail, basing on the examples of embodiments and referring to the attached figures, where:

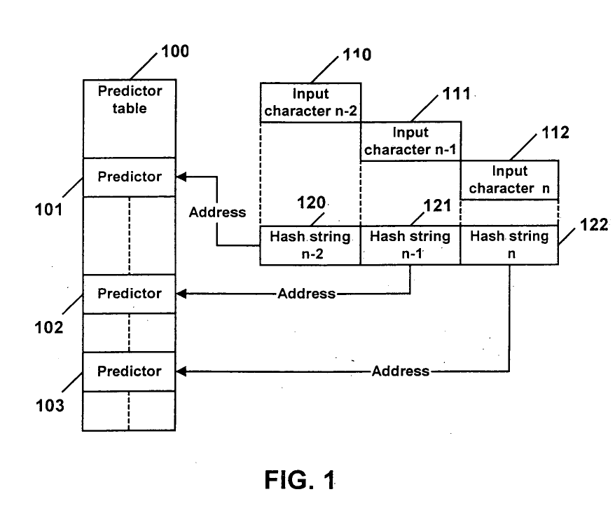

FIG. 1 shows data structure according to the first and the simplest embodiment of the invention;

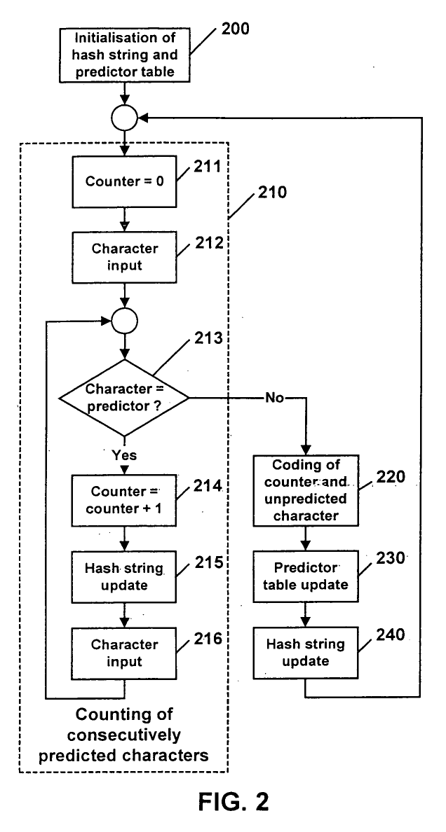

FIG. 2 shows block diagram illustrating the data compression process according to the first embodiment of the invention.

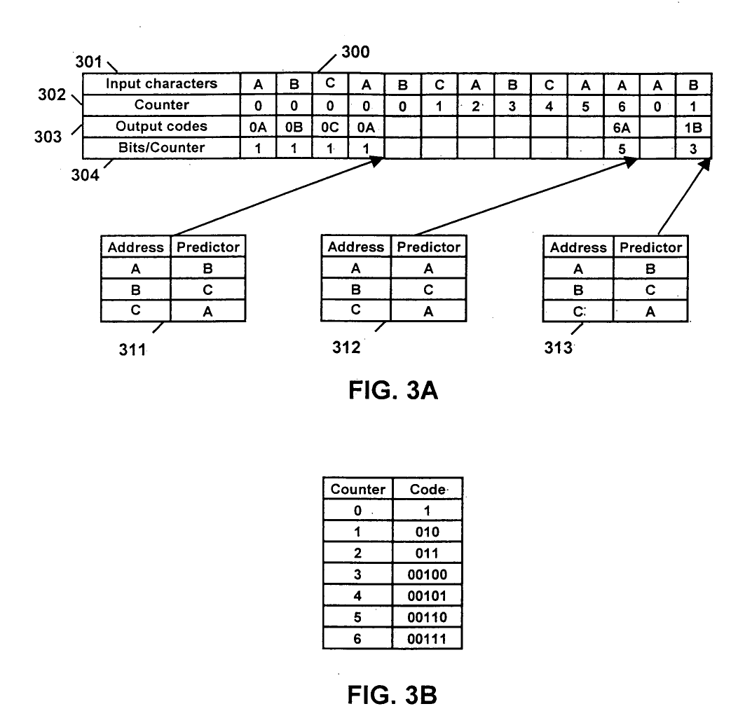

FIG. 3A and FIG. 3B show flowchart, which illustrates the compression process of a sample of character sequence according to the first embodiment of the invention.

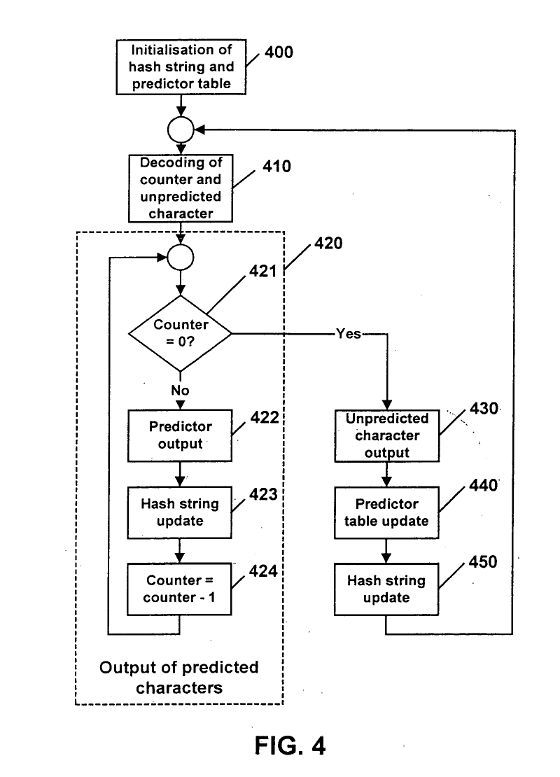

FIG. 4 shows block diagram illustrating the data decompression process according to the first embodiment of the invention.

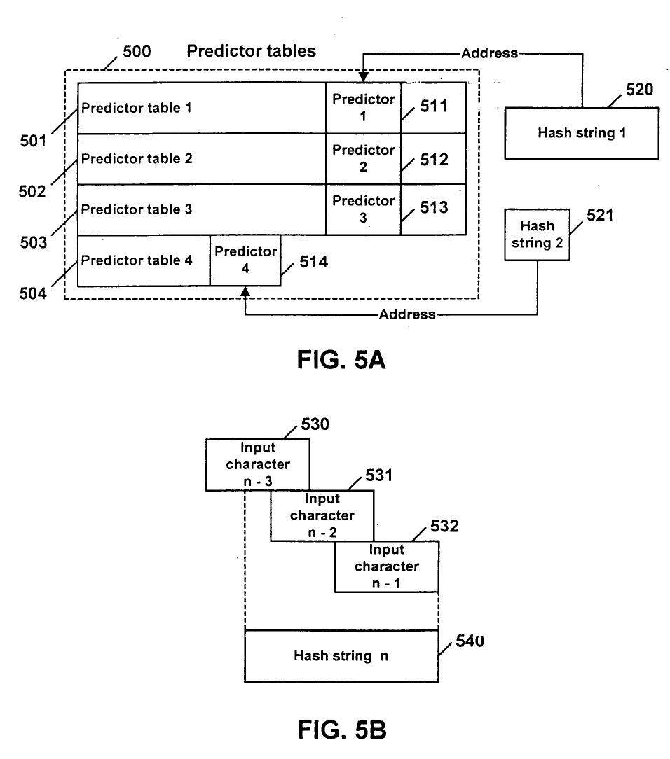

FIG. 5A and FIG. 5B show data structure according to the second embodiment of the invention.

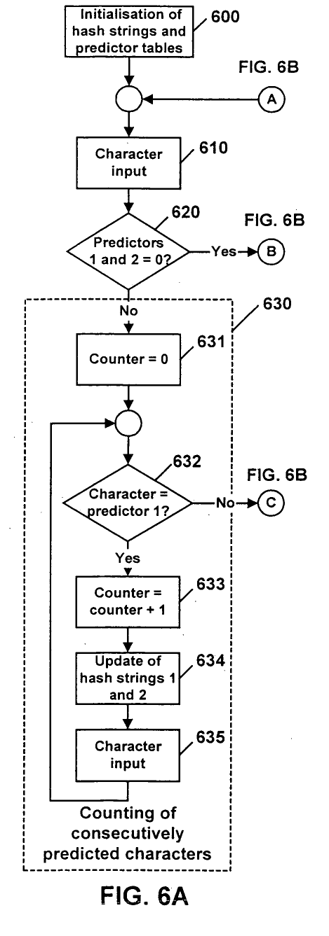

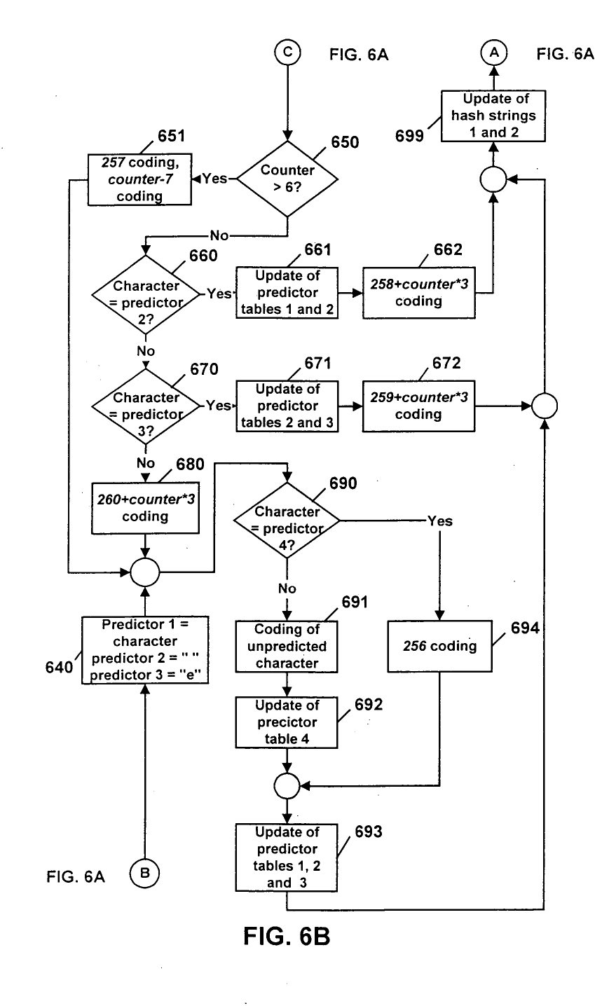

FIG. 6A and FIG. 6B show block diagram illustrating the data compression process according to the second embodiment of the invention.

Data compression method according to this invention, depending on such requirements as compression speed, compression rate, required memory space and simplicity of implementation, can be realized in more or less complicated ways. In order to give easier a clear and understandable idea of the essence of the present invention, hereinafter, referring to FIG. 1 up to FIG. 4, we are going to explain one of embodiments of the invention, which is directed towards high compression speed, little memory space required and maximum simplicity.

In this embodiment of the invention one hash function is used to form the hash string from the input data character stream. As this implementation of the method according to the invention is directed towards maximum speed and a little memory space required, a simple hash function, with a string length equal to the length of one character, is chosen; but its current value is always equal to the previously processed character (HASH=LastChr), except the beginning of the process where a zero value is assigned to a hash string in the initialization step. FIG. 1 depicts input characters 110, 111 and 112, by consecutive processing of which the values of previously processed characters 120, 121 and 122 are assigned to the hash string respectively.

Hash string is used for addressing the cells in a special storage area—predictor table 100 (FIG. 1). As this embodiment of the invention is directed towards a high compression speed, a little memory space required and simplicity, one table is used for storing of predictors. Taking into account the historically developed situation that in the data processing systems the length of one character is usually taken as 8 bits, the length of character and the length of predictor are taken as 8 bits also in this embodiment of the invention. Thus the hash string can take on 256 different values and therefore it is able to address 256 cells in the predictor table. It, in its turn, defines the memory space required for table 100, which in this particular case is only 256 bytes.

At the beginning of the compression process the predictor table 100 is initialized by filling its cells with zeros. During processing the characters of input data stream they are compared with the corresponding values addressed by hash string in the predictor table, namely, with predictors. In FIG. 1 it is seen that input character 110 is compared with a predictor 101, input character 111—with a predictor 102 and input character 112—with a predictor 103. Thereby, during processing the input characters, attempts are made to predict them. For counting of consecutively predicted characters a counter to which a zero value is assigned at the beginning of the process is used.

In the case of a negative result of comparison the current value of counter is coded by the Elias Delta Code (FIG. 3B) and output together with the unpredicted character. The content of the predictor table is also updated by recording the unpredicted character in the same cell with the value of which comparison was made, thus the dynamically changing information about the input data stream is accumulated in the predictor table.

As a result the output code stream is obtained having coded values of a number of consecutively predicted characters and unpredicted characters. FIG. 3A shows a simplified example of input data character stream 301, corresponding counter values 302 obtained by processing of each character, output stream 303, as well as the number of required bits 304 to output the coded counter value. In tables 311, 312 and 313 the states of predictor table are shown. As only three different characters are used in this simplified example of processing the input data character stream, also the hash string can take on only these values accordingly. It is seen from the table state 311 that the predictors accumulated in the compression process are already stored under three possible addresses, and further the series where input characters match the predictors addressed by the hash string continues. It is clearly demonstrated here, how the adaptation stage is followed by the series of prediction cases of input characters, what is the key principle of the data compression method according to the invention. According to the example, the input stream fragment shown there consists of 13 characters (13*8=104 bits). Output stream contains 6 unpredicted characters (6*8=48 bits) and coded counter values (1+1+1+1+5+3=12 bits). It clearly demonstrates the result of the compression process in which 60 bits of one-to-one recoverable coded output stream are obtained from 104 bits of input characters.

The compression process is shown in FIG. 2 in detail. At first a step 200 is performed where zero value is assigned to the hash string. In this step 200 the predictor table is also initialized by filling its cells with zeros. It is followed by a set of steps 210 where the number of the consecutively predicted data characters is obtained. It in its turn, consists of several steps. In a step 211 zero value is assigned to the counter. It is followed by character input in a step 212, but in a step 213 it is checked whether the input character matches the predictor value addressed by the hash string. If the result of check is positive, then in a step 214 the counter is incremented by one and, according to the previously described hash function used in a step 215, the hash string is updated by assigning to it the value of the predicted character being processed. After that in a step 216 the next character input is performed and followed by returning back to the check step 213. If the result of check in the step 213 is negative, then in a step 220 counter value is coded by Elias Delta Code and output together with the unpredicted character, thus creating the stream of compressed data. Then in a step 230 the content of predictor table is updated by recording the unpredicted character in the same cell with the value of which comparison has been made. Further on in a step 240 the hash string is updated by assigning to it the value of the unpredicted character and returning to the step 211 described above takes place. The process is continued in a loop, and as a result the compressed and one-to-one recoverable data stream is obtained.

In a decompression process the initial data stream is obtained after decoding that corresponds to coding by processing the stream of counter values and unpredicted characters. The decompression process is shown in FIG. 4. At the beginning a step 400 is performed, where the hash string and predictor table are initialized. In this step 400 the same values are assigned to the hash string and to the cells of predictor table which were used in the initial step 200 of data compression (FIG. 2) and which, in this embodiment of the invention, are zeros. In the next step 410 the compressed data stream is decoded and the counter value and unpredicted character are obtained. Afterwards it is checked in a step 421 whether the counter value equals zero. If the result of check is positive, then in a step 430 said unpredicted character is output. Then in a step 440 the content of the predictor table is updated by storing this unpredicted character into the cell addressed by the hash string. Further on in a step 450 the hash string is updated by assigning to it the value of the output unpredicted character, which is followed by returning to the step 410 described above. If the result of check in the step 421 is negative, then in a step 422 the predictor addressed by the hash string is output from the predictor table. Then in a step 423 the hash string is updated by assigning to it the value of the predictor output in the step 422. Further on in a step 424 the counter is decremented by one and the return to the step 421 of checking the counter value takes place. As a result, by cyclical repeating the set of steps 420 until the counter value reaches zero, the characters consecutively predicted in the compression process are output. In such a way the initial data stream is obtained, by outputting the characters predicted and unpredicted in the compression process.

Further a more complicated embodiment of the invention will be described, by implementation of which a substantially higher compression rate can be achieved, if compared with the embodiment described above.

As it is shown in FIG. 5A, there, unlike the first embodiment of the invention, four predictor tables 501, 502, 503, 504 are used for storing the predictors and two hash functions are used for forming hash string 1 (520) and hash string 2 (521) respectively. Moreover, the hash string 1 (520) is used for addressing in three predictor tables 1, 2 and 3 (501, 502 and 503 respectively) at once, but the hash string 2 (521)—for addressing in one predictor table 4 (504).

By using several predictor tables that are addressed by one hash string it is achieved that in the compression process the variants of predictors accumulates in said predictor tables. If comparison of the character being processed with the predictors in these tables is performed in succession, starting from the first table, then, by applying appropriate strategy of updating of the predictor tables, it is achieved that in compression process the variants of predictors usually distributes in such a way, that the predictor occurring most frequently is stored in the table 1, while the others are stored in tables 2 and 3 according to their frequency of occurrence, in decreasing order.

As shown in FIG. 5B, one of hash functions forms a hash string 1 (540) (FIG. 5A—520 accordingly) from the three previously processed characters 530, 531 and 532 by performing XOR logical function for the three lower bits of one character with three higher bits of the next character and by keeping 15 lower bits of the result (HASH=((HASH<<5)\hat{ }LastChr)&0x7FFF), except the beginning of the process, when a zero value is assigned to the hash string in the initialization step.

The second hash function used is the same as in the first embodiment of the invention. The length of its string (521, FIG. 5A) equals to the length of one character, but its current value is always equal to the previously processed character (HASH=LastChr), except the beginning of the process when a zero value is assigned to the hash string in the initialization step.

So, during processing a particular input character, the current hash strings address the predictors in corresponding predictor tables. As depicted in FIG. 5A, the hash string 1 (520) addresses a predictor 1 (511), a predictor 2 (512) and a predictor 3 (513), while the hash string 2 (521) addresses a predictor 4 (514). As the length of character in the present embodiment of the invention is taken as 8 bits, the length of the hash string 1 (520) is 15 bits, but the length of the hash string 2 (521) is 8 bits. That, in its turn, defines the capacity of the predictor tables, i.e., the predictor tables 1, 2 and 3 require 32 kilobytes while the predictor table 4—256 bytes.

Combined use of several different hash functions ensures, that adaptation speed and suitability for various data types are increased. As a result, it allows obtaining higher compression rate of the data stream.

The compression process in detail, step by step is show in FIG. 6A and FIG. 6B. At first an initialization step 600 is performed where zero values are assigned to hash strings. In the step 600 predictor tables are also initialized by filling their cells with zeros. Further in a step 610 input of a character follows and in a step 620 it is checked whether a predictor 1 and a predictor 2 addressed by the hash string 1 are equal to zero. If the check result in the step 620 is negative, i.e., if at least one of the checked predictors is not equal to zero, then a step set 630 is performed in which the number of consecutively predicted input data characters is obtained by means of counter. The step set 630 is started with a step 631 where zero value is assigned to the counter. Further, in a step 632 it is checked, whether the character being processed matches the predictor 1 addressed by the hash string 1. If by checking it is found that the character being processed matches predictor 1, then a step 633 is performed in which the counter is incremented by one. Then in a step 634 the values of the hash string 1 and the hash string 2 are updated using the above described hash functions accordingly. Further, in a step 635 the next character input follows from the input data stream, and returning to the step 632 takes place. Thus the number of consecutively predicted data characters is accumulated in the counter.

If by checking in the step 632 the mismatch is found between the character being processed and the predictor 1, then a step 650 is performed to check whether the counter value is greater than 6. If by checking it is found that the value of the counter is greater than 6, then a step 651 is performed where the code 257 is coded and output, and after that the counter value, reduced by 7 (counter-7) is coded and output.

Then a step 690 follows where the match between character being processed and the predictor 4 addressed by the hash string 2 is checked. If the check result is positive, a step 694 follows where the code 256 is coded and output. Further in, a step 693 the content of predictor table 1, predictor table 2 and predictor table 3 is updated. In the updating process the predictor 2 addressed by the hash string 1 from the predictor table 2 is transferred to the cell of predictor table 3, which is addressed by the hash string 1. Then in the predictor table 2 in the cell addressed by the hash string 1 the character being processed is stored while the predictor table 1, according to updating strategy chosen for this embodiment of the invention, remains unchanged. Further in a step 699 by appropriate using of the above described hash functions the hash string 1 and the hash string 2 are updated, and returning to the character input step 610 is undertaken.

If the result of check performed in the step 690 is negative, a step 691 is performed where the processed character is coded and output as an unpredicted character. Then a step 692 follows where the predictor table 4 is updated. In the updating process in the predictor table 4 the predictor 4 addressed by the hash string 2 is replaced by said unpredicted character. Further the above described steps 693, 699 are consecutively performed, and returning to the character input step 610 takes place.

If by checking in the step 650 it is found that the counter value is equal to 6 or less, then a step 660 is performed where the match between the character being processed and the predictor 2 addressed by the hash string 1 is checked. If the check result is positive, then a step 661 is performed where the content of predictor table 1 and predictor table 2 is updated. In the updating process the predictor 1 addressed by the hash string 1 is transferred from the predictor table 1 to the cell of the predictor table 2, which is addressed by the hash string 1. In its turn, in the predictor table 1 into the cell addressed by the hash string 1 the character being processed is stored. As a result, values of the predictor 1 and the predictor 2 addressed by the hash string 1 are interchanged. Further a step 662 is performed where the code 258+counter*3 is coded and output. Then the step 699 follows where, by appropriate using the hash functions described above, the hash string 1 and the hash string 2 are updated, and returning to the character input step 610 takes place.

If the result of check performed in the step 660 is negative, then a step 670 is performed where the match between the character being processed and the predictor 3 addressed by the hash string 1 is checked. If the result of check undertaken in the step 670 is positive, then a step 671 is performed where the content of predictor table 2 and predictor table 3 is updated. In the updating process the predictor 2 addressed by the hash string 1 from the predictor table 2 is transferred to the predictor table 3, to cell addressed by the hash string 1. In its turn, in the predictor table 2 in the cell addressed by the hash string 1 the character being processed is stored. As a result, the values of the predictor 2 and the predictor 3 addressed by the hash string 1 are interchanged. Further a step 672 is performed where the code 259+counter*3 is coded and output. It is followed by the step 699 in which by appropriate using the above described hash functions, the hash string 1 and the hash string 2 are updated, and returning to the character input step 610 takes place.

If the result of check performed in the step 670 is negative, then a step 680 is performed where the code 260+counter*3 is coded and output. Further the above described step 690 and successive steps follow.

Here in the description of the compression process we are returning to the step 620 described before where it is checked whether the predictor 1 and the predictor 2 addressed by the hash string 1 are equal to zero. If the result of check performed in the step 620 is positive, then a step 640 is performed where the content of predictor table 1, predictor table 2 and predictor table 3 is updated in such a way, that the value of character being processed is assigned to the predictor 1 addressed by the hash string 1, the value of character ‘ ’ (20H) is assigned to the predictor 2 and to the predictor 3 the value of character ‘e’ (65H) is assigned. Further the above described step 690 and successive steps follow. In such a way the values of the predetermined characters with the potentially most frequent occurrence are assigned to the cells of the predictor tables which, after the initialization at the beginning of process, in the further compression process are still not occupied, that increases the number of predicted characters and improves the compression rate of the data stream.

In the steps 651, 662, 672, 680, 691, 694 of compression process the information is coded and output thus forming the stream of compressed data. As the character length is taken as 8 bits, the possible character codes are within the range of from 0 to 255. Therefore in the steps 651, 662, 672, 680, 694 the codes above this range are used for forming the output information, beginning with the code 256, thus providing the possibility to identify unambiguously the actions, that have taken place during the compression process, and accordingly to restore the original data stream one-to-one in the decompression process.

In order to increase the compression rate, it is advisable to use an entropy coder for coding of prepared information, which can be chosen among several widely known coders, such as Huffman, Range or Arithmetic coder. Thus, Huffman coder is used for coding in the above mentioned steps of the described embodiment of the invention, except the step 651. In the step 651, the value 257 is coded with

Huffman coder while the value counter-7 is coded with Elias Delta Code. That is because the value counter-7 can reach great values for which the Huffman coder will be ineffective. Checking of the counter value in the step 650 (counter>6) gives an opportunity to limit the alphabet used, thus adapting to further effective coding with the Huffman coder.

The decompression process was described in detail by disclosing the first embodiment of the invention, and in this example it is performed in a similar way, according to the particular performing of compression. For skilled person, using information about the compression process, there will be no problems to perform both the decompression process of the second embodiment of the invention described above and to implement other more or less complicated cases of compression and decompression using the method according to this invention.

In the described embodiments of the invention, the steps of checking whether the input data stream has not finished are not described in detail. This is a routine operation, well known to those skilled in the art and its inclusion would only hinder clearness and easier understanding of the compression disclosure.

The method according to the invention is described and explained by the above embodiments of the invention, which in no way limit the variety of possible implementations and the scope of this invention.

Thus, for example, in the described embodiments of the invention, the predictor tables are updated in the compression process, while cases are possible where the structure of the data to be compressed is already known, and the implementation of method without the updating of predictor tables will be more efficient. In this case the content of predictor table is prepared before and is not updated during the compression process.

Furthermore, an alternative implementation is possible where the predictor tables are initialized at the beginning of the compression process using the content prepared beforehand, and further updated during the compression process. Such variant of implementation can be efficient, when the structure of the data to be compressed is partly known.

When several predictor tables are used it is possible to apply different updating strategies for different predictor tables. Such combined use of strategies enables the application of data compression method according to the invention for a variety of purposes. In the above described second embodiment of the invention, during updating of predictor tables, the predictor values are transferred between the tables which provides storing of more frequently occurring values in the predictor tables, with which comparing of the processed character is begun. Also in such cases applying of different strategies is possible that will not cause any problems to a skilled person to implement them of necessity for achieving particular goals. Furthermore, according to the invention, several different hash functions can be used, the combination of which provides higher adaptation speed and better suitability for different types of the data to be compressed. As a result, this allows reaching the higher compression rate.

In the described embodiments of the invention the steps are performed in succession, but it is possible to have the implementations of the method where at least part of the steps are performed in parallel. For example, it is possible to make parallel comparison of the current character being processed with several predictors that provides the higher compression speed.

The method according to the invention can be used separately or together with other methods. Besides, the high level of predictability of a running time is the distinguished feature of this method, i.e., the implementations are possible where, irrespective of the character of input data stream, its processing time is predictable and can also be fixed.

1. A method for coding an input data character stream to obtain a compressed output code stream, said method comprising the steps of:
counting consecutively predicted characters by comparing a character of the input data character stream with a predictor stored in a predictor table and addressed by a hash string, said predictor table comprising a plurality of predictors, said predictors being the characters of the input data stream and/or predetermined values, and said hash strings being formed by means of a hash function correlative with the input data;
coding a number of the consecutively predicted characters and an unpredicted character immediately succeeding the consecutively predicted characters;
optional updating the predictor table by storing the unpredicted character into a cell of the predictor table, said cell being addressed by said hash string;
updating the hash string.

2. The method according to claim 1, wherein the coding step further comprises the steps of:
comparing said unpredicted character with a predictor stored in the next predictor table;
coding the number of the consecutively predicted characters and an identifier of said next predictor table, if said unpredicted character matches the predictor stored in said next predictor table; or
coding the number of the consecutively predicted characters and the unpredicted character immediately succeeding the consecutively predicted characters, if said unpredicted character does not match the predictor stored in said next predictor table.

3. The method according to claim 2, wherein, in case said unpredicted character does not match said predictor stored in said next predictor table, the steps are performed in a recursive way, until all the existing predictor tables are used.

4. The method according to claim 3, wherein two or more hash strings are used for addressing the predictors in various predictor tables, each hash string being formed by means of an unique function correlative with the input data.

5. The method according to claim 3, further including an optional step of updating the predictor tables in accordance with a predetermined strategy.

6. The method according to claim 3, wherein the character of input data stream is compared in parallel with the predictors stored in two or more existing predictor tables.

7. The method according to claim 1, further comprising the step of initiating said hash string at the beginning of the process, in which a predetermined value is assigned to said hash string.

8. A method of decompression for obtaining an initial input data character stream from the compressed code stream obtained by the compression method according to claim 1, the decompression method comprising the steps of:
decoding a number of consecutively predicted characters and an unpredicted character immediately succeeding the consecutively predicted characters;
outputting the predicted characters by retrieving a predictor stored in a predictor table and addressed by a hash string, the retrieving being continued until the initial value assigned to the counter in the compression process is reached;
outputting the unpredicted character;
optionally updating the predictor table by storing the unpredicted character into a cell of the predictor table, the cell being addressed by the hash string; and
updating the hash string.

9. Apparatus for coding an input data character stream in order to obtain a compressed output code stream, the apparatus comprising:
a predictor table comprising a plurality of predictors, said predictors being the characters of the input data stream and/or predetermined values;
counting means arranged to count, in use, consecutively predicted characters by comparing a character of the input data character stream with a predictor stored in a predictor table and addressed by a hash string, wherein the hash string is formed by means of a hash function correlative with the input data;
first coding means arranged to code, in use, a number of consecutively predicted characters and an unpredicted character immediately succeeding the consecutively predicted characters;
predictor table updating means arranged, in use, to optionally update the predictor table by storing an unpredicted character into a cell of the predictor table, said cell being addressed by said hash string; and
updating means arranged, in use, to update the hash string after the predictor table has been updated.

10. The apparatus according to claim 9, wherein the first coding means further comprises:
comparing means arranged to compare, in use, said unpredicted character with a predictor stored in the next predictor table;
second coding means for coding, in use, a number of the consecutively predicted characters and an identifier of said next predictor table, if said unpredicted character matches the predictor stored in said next predictor table or coding the number of the consecutively predicted characters and the unpredicted character immediately succeeding the consecutively predicted characters, if said unpredicted character does not match the predictor stored in said next predictor table.

11. The apparatus according to claim 10, wherein the apparatus is arranged such that, in the case said unpredicted character does not match said predictor stored in said next predictor table, the comparing means and second coding means are arranged to function, in use, means in a recursive way, until all existing predictor tables are used.

12. The apparatus according to claim 11, wherein the apparatus is arranged such that two or more hash strings can be used for addressing the predictors in various predictor tables, each hash string being formed by means of an unique hash function correlative with the input data.

13. The apparatus according to claim 11, optionally comprising means for updating the predictor tables in accordance with a predetermined strategy.

14. The apparatus according to claim 11, further comprising means for parallel comparing the character of input data stream with the predictors stored in two or more existing predictor tables.

15. The apparatus according to claim 9, further comprising means adapted for initiating said hash string at the beginning of the process by assigning a predetermined value to said string.

16. A decompression apparatus for obtaining an initial input data character stream from a compressed code stream obtained with the compression apparatus according to claim 9, the apparatus comprising:
decoding means arranged to decode, in use, a number of consecutively predicted characters and an unpredicted character immediately succeeding the consecutively predicted characters;
a predictor table comprising a plurality of predictors, said predictors being the characters of the input data stream and/or predetermined values;
retrieval means arranged to retrieve, in use, a predictor stored in the predictor table and addressed by a hash string, wherein the retrieving is continued, in use, until the initial value assigned to the counting means in the compression apparatus is reached;
output means arranged to output, in use, predicted characters retrieved by the retrieval means and an unpredicted character;
predictor table updating means arranged, in use, to optionally update the predictor table by storing an unpredicted character into a cell of a predictor table, the cell being addressed by the hash string;
hash string updating means arranged, in use, to update the hash string after the predictor table has been updated.
